(19) United States
(12) Patent Application Publication
(10) Pub. No.: US 2003/0218338 A1
(43) Pub. Date: Nov. 27, 2003

(54) Apparatus and method for extracting maximum power from flowing water

(76) Inventors: George A. O'Sullivan, Delray Beach, FL (US); Conrad Pecile, Easton, PA (US)

Correspondence Address: KLAUBER & JACKSON, 411 HACKENSACK AVENUE, HACKENSACK, NJ, 07601

(21) Appl. No.: 10/155,190

(22) Filed: May 23, 2002

(51) Int. Cl. H02P 9/04; F03B 13/00; F03B 13/10

(52) U.S. Cl. 290/43

(57) ABSTRACT

An apparatus and method for extracting a maximum amount of power from a water source includes: a hydroturbine assembly including a shaft; a turbo generator connected to the shaft of the hydroturbine assembly; a frequency sensor for sensing a frequency output by the generator associated with a turbine speed of the hydroturbine; a power converter that converts the electrical output of the turbo generator to a predetermined power value; a power sensor for sensing an output power of the power converter; a maximum power controller that maximizes a power output of the power converter based on: (a) the frequency of the electrical output of the turbo generator sensed by the frequency sensor; and (b) the output power of the power converter sensed by the power sensor; and an energy reservoir for receiving the output of the power converter; wherein the maximum power controller calculates a maximum power output of the power converter. An algorithm permits the maximum power controller to extract the maximum available power at levels that approach stall torque. Power and frequency information are transmitted over the same pair of wires.

This application was funded in part by a grant from the U.S. Government, which retains a non-exclusive license to practice this invention.

### BACKGROUND OF THE INVENTION

1. Field of the Invention

The present invention relates to systems used for extracting electrical power. More particularly, the present invention relates to hydroelectric power generation systems.

2. Description of the Related Art

The generation of electrical power by the use of water (hydroelectricity) has been considered one of the safest and cleanest ways to generate electricity, without damaging the environment with pollutants as compared to the generation of electricity by burning coal, oil, gas, or nuclear reactors.

Generating electricity from dammed waterways was the original way that hydropower was utilized. However, the costs associated with the construction of dams often made hydropower an impractical choice. Aside from the substantial monetary requirements for building a dam capable of safely securing water, there is required a permanent investment in real estate. In addition, the building of a dam impedes river commerce and blocks the passage of fish.

The waterways that have sufficient velocity and volume of water flow necessary for the generation of electric power without the construction of dams are rapid rivers, such as the Yukon River in Alaska; tides where large inland bodies of water connect to the oceans through small inlets, such as the San Francisco Bay; and ocean currents that are close enough to land to make transmission practical, such as the Gulf Stream by the southern coast of Florida.

There has been a need in the art to extract electric power from flowing water without the problems associated with building dams. Such a goal is now at least practical by the emergence of advancements in hydro turbines and power electronics.

There is also a need to increase the efficiency of prior art hydroelectric systems by increasing the available power to the largest extent possible. With the variations in the flow of water, the amount of power that can be extracted at any particular instant in time also varies, and to increase the reliability and feasibility of using hydroelectric power, maximizing the extraction of power during peak periods is needed.

### SUMMARY OF THE INVENTION

Accordingly, it is a first object of the present invention to extract the maximum possible power from hydroturbines for all practical velocities of water flow.

A second objective of the present invention is to provide a practical means of seeking and finding the maximum power point. In order to seek and find the maximum power point and permit the maximum extraction of power, it is necessary to communicate the data regarding the hydroturbine speed.

The present invention provides a novel approach to communicating the hydroturbine data, so that there is a great savings, because it is not required to provide separate wires for communication of the hydroturbine speed data. According to the present invention, the turbine speed data is communicated on the same two wires used to transmit the power. This in turn, permits the power conversion system to have all the required data to compute the maximum available power with receipt of the power transmission.

A third objective of the present invention is to deliver the electric power from a hydroelectric system in an efficient manner to a load capable of absorbing all of the power available from the hydroturbines at any particular moment in time.

Yet another objective of the present invention is to convert the turbine generator ac output to dc by means of rectifiers, and to regulate the dc voltage at the vessel that contains the turbine generator(s). By regulating the voltage, advantages heretofore unknown to artisans include that current remains proportional to the power, and thus only the current needs to be measured; also, the cable losses decrease with a decreasing water velocity.

In still another objective of the present invention, the present invention provides a method and apparatus for maximum power tracking for devices such as a tethered, underwater, water-current turbine or turbines, including those devices which may have variable depth control and/or variable pitch rotor blades.

In a first aspect of the invention, an apparatus for extracting a maximum amount of power from a water source comprises:

a hydroturbine assembly including a shaft;

a turbo generator connected to the shaft of the hydroturbine assembly;

a frequency sensor for sensing a frequency output by the generator associated with a turbine speed of the hydroturbine;

a power converter that converts the electrical output of the turbo generator to a desired value;

a power sensor for sensing an output power of the power converter;

maximum power controller means that maximizes a power output of the power converter based on: (a) the frequency of the electrical output of the turbo generator sensed by the frequency sensor; and (b) the output power of the power converter sensed by the power sensor; and

an energy reservoir for receiving the output of the power converter;

According to another aspect of the invention, the maximum power controller means maximizes the power output of the power converter according to the following algorithm:

(i) initializing the power output at a predetermined low power reference point PREF;

(ii) introducing a pause of a predetermined amount of time to permit transient values to settle;

(iii) measuring an input power p and frequency f provided to the maximum power converter means from the turbo generator and the frequency sensed;

(iv) decrementing the reference power PREF (iii) by a predetermined amount if it has been determined that the power p measured in step (iii) exceeds a maximum permitted power value (PMAX) and returning to step (ii).

(v) calculating a stall torque power (PSTALL) according to the frequency and power measured at step (iii);

(vi) determining whether the stall torque power is greater than the power p in step (iv) that is below the maximum permitted power value; and one of

(vii) decrementing the reference power PREF by a predetermined amount if the value of the stall torque power PSTALL is greater than the power p and returning to step (ii); or

(viii) incrementing the reference power PREF by a predetermined amount if the value of the stall torque power is greater than the power p and returning to step (ii).

In yet another aspect of the invention, an apparatus for extracting maximum power from water, typically where there is long distance between the turbines and the utility, such as an ocean, comprises:

a pair of hydroturbines having shafts;

a pair of generators, each one of the pair of generators being connected to a respective one of said pair of hydroturbines;

a pair of rectifiers, each one rectifier being connected to an output of a respective one of said pair of generators;

a transmission regulator that receives a rectified power output from said pair of rectifiers, said transmission regulator outputting a constant predetermined high dc voltage;

a frequency divider that receives an unrectified output from said pair of hydroturbines, said frequency divider dividing a frequency of the unrectified output to a low frequency that is proportional to shaft speed of at least one of the pair of hydroturbines;

a transmission converter that reduces the constant high dc voltage output from the transmission regulator to a lower dc voltage;

means for maintaining a constant current output from the transmission converter; and

a maximum power controller that controls the means for maintaining a constant current output from the transmission regulator,

a modulator for modulating the high dc voltage by the low frequency proportional to shaft speed output from the frequency divider, so that the maximum power controller receives the current from the transmission regulator and the frequency information over the same two wires.

In still another aspect of the invention, current control can be utilized, as the maximum power controller utilizes maximum power tracking according to the following algorithm:

(i) initializing a current output at a predetermined low current reference point IREF;

(ii) introducing a pause of a predetermined amount of time to permit transient values to settle;

(iii) measuring an input current I and frequency f provided to the maximum power controller from the pair of turbo generators and the frequency sensed;

(iv) decrementing the current reference (IREF) by a predetermined amount if it has been determined that the current I measured in step (iii) exceeds a maximum permitted current value (IMAX), and returning to step (ii);

(v) calculating a stall torque current (ISTALL) according to the frequency and power measured at step (iii), wherein ISTALL=m*F+b;

(vi) determining whether the stall torque current is greater than the current I in step (iv) that is below the maximum permitted current value; and one of

(vii) decrementing the current reference (IREF) by a predetermined value if the value of the stall torque current is greater than the current I and returning to step (ii); or

(viii) incrementing the current reference (IREF) by a predetermined value if the value of the stall torque current is greater than the current I and returning to step (ii).

According to still another aspect of the present invention, a propeller speed communication link comprises:

means for receiving an alternating current having three phases generated by a propeller turbine;

a rectifier connected to the means for receiving, said rectifier outputting a main dc signal output and a reference signal;

a frequency detection transformer connected to the means for receiving an alternating current, said frequency detection transformer receiving one phase of said three phases of the alternating current;

a frequency divider that is connected to an output of the frequency detection transformer;

an adder having a first input connected to an output of the frequency divider, and a second input connect to the reference signal for a boost regulator;

a boost regulator that has a first input that receives the main dc signal and a second input that receives an output of the adder, wherein said boost regulator modulates the main dc signal according to the output of the adder, so that the main dc signal and frequency information regarding a speed of the propeller turbine are transmitted over a same two-wire output.

The propeller speed communication link may further comprise means for communicating emergency information regarding a failure or a degradation of at least one component of the alternator, rectifier, frequency detect transformer, adder or boost regulator.

According to still another aspect of the present invention, a method for extracting maximum power may comprise:

(a) providing a pair of hydroturbines having shafts and a pair of three-phase generators, each one of the pair of three phase generators being connected to a respective one of said pair of hydroturbines;

(b) dividing an output frequency of at least one phase of one of the pair of three-phase generators, so that said output frequency is divided to a lower frequency that is proportional to shaft speed of at least one of the pair of hydroturbines;

(c) providing a pair of three-phase rectifiers, each three-phase rectifier being connected to an output of one of said pair of three-phase generators;

(d) combining the power from said pair of three-phase rectifiers to a single direct current output voltage;

(e) regulating the output current of the dc voltage by a regulator including a maximum power controller;

(f) modulating the high dc voltage by the low frequency proportional to shaft speed output from the frequency divider;

(g) providing the modulated dc voltage in step (f) and the frequency information generated in step (b) so that the maximum power controller receives the output current and frequency information over the same two wires.

The regulating in step (e) may include providing a transmission converter for converting the predetermined dc voltage output to a lower dc voltage level.

### BRIEF DESCRIPTION OF THE DRAWINGS

FIG. 1 illustrates a block diagram of a water current power generator.

FIG. 2 illustrates a calculated family of curves for a dual hydroturbine system.

FIG. 3 illustrates a flowchart for finding maximum power according to the present invention.

FIG. 4 illustrates a system block diagram for an ocean current power generator according to the present invention.

FIG. 5 illustrates a graph of frequency versus current to shore for an ocean power generator.

FIG. 6 illustrates an algorithm for maximum power tracking having current as the controlled variable.

FIG. 7 illustrates a propeller speed communication link.

### DETAILED DESCRIPTION OF THE PREFERRED EMBODIMENTS

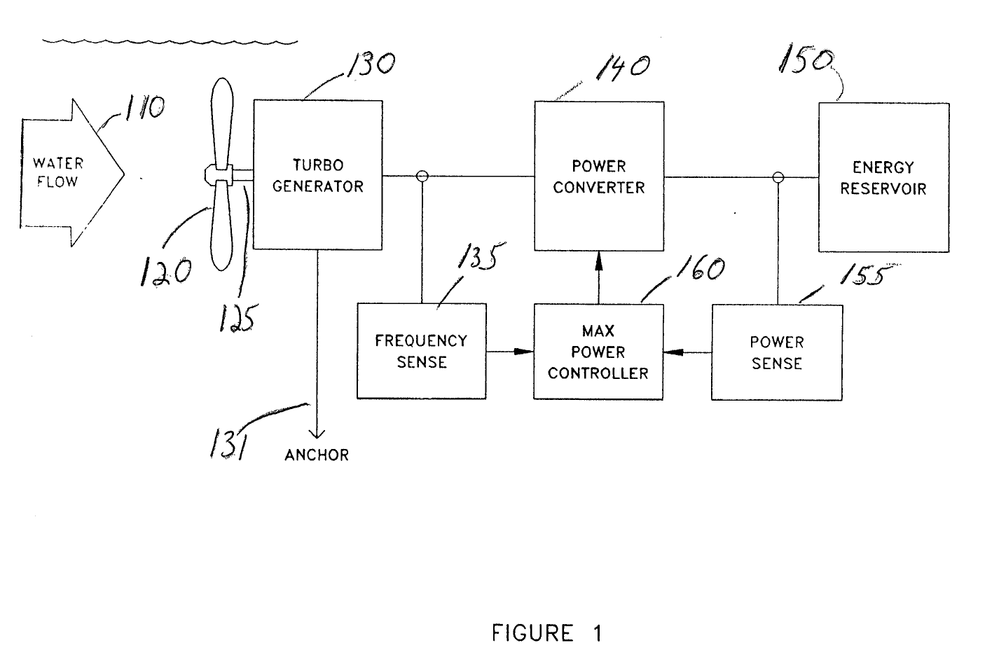

FIG. 1 illustrates a block diagram of a water flow power generator having a maximum power controller. Water flow causes a hydroturbine to rotate. The shaft 125 of the hydroturbine is in physical contact with a rotor (not shown) in the turbo generator assembly 130, so that the mechanical energy caused by the motion of the hydroturbine is converted to electrical energy. The turbo generator assembly 130 is held in place by anchor 131. However, the turbo generator can also be held in place by other methods, such as a platform (which can be stationary or mobile) or any other method, so long as the hydroturbine 120 remains in the main stream of the water flow.

A power converter 140 receives the output of turbo generator 130, which in turn delivers a power output that is received by energy reservoir 150 either for storage or for immediate use. The energy reservoir in an embodiment is a battery, and the power converter 140 comprises a battery charger. Alternatively, the energy reservoir can also comprise: a flywheel, and the power converter includes an electric motor to add inertia to the flywheel; a utility grid, and the power converter includes an inverter for delivering power to the utility distribution system; or any suitable energy reservoir that can be connected through energy transfer means to the turbo generator.

The power converter 140 is controlled by the maximum power controller 160, which uses turbine speed output from frequency sensor 135 and output power from power sensor 155 to seek and find the maximum power available from the system.

With regard to calculating turbine speed, the turbine has a nonlinear speed-torque relationship that varies with the water velocity. When torque is applied to the turbine that exceeds the power available from the water flow, the turbine will cease to turn. The amount of torque that prevents the turbine from turning is referred to as the stall torque. The speed-torque relationship for the turbine can be calculated, or in a more practical manner, the speed-torque relationship can be calibrated by applying a variable electrical load to a hydroturbine connected to an electric generator at different water velocities.

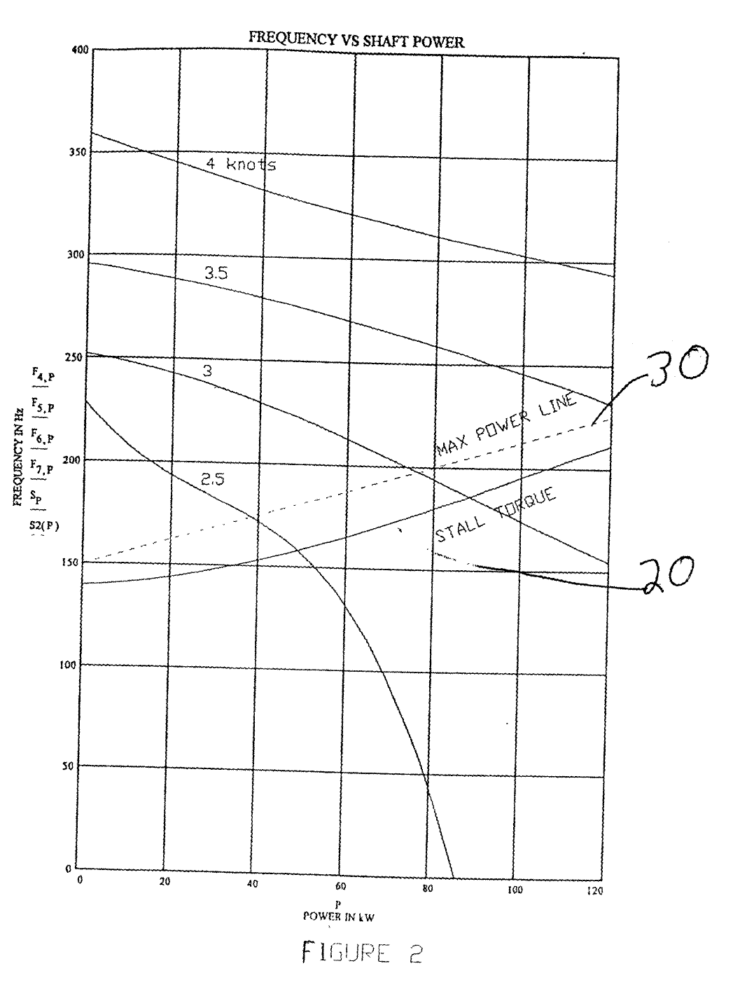

FIG. 2 illustrates a calculated family of curves for a hydroturbine connected to an electric generator, wherein the data is presented as a plot of shaft power versus generator frequency. For the particular illustration, the hydroturbine is a dual hydroturbine system that is rated at 120 kW at a water velocity of 3.5 knots (1.8 m/sec). The stall torque curve 20 is included. While the actual maximum power curve is slightly above the stall curve, it would be of little value to operate at that level because even a slight reduction in water velocity would cause a stall that would disrupt power generation. Accordingly, it is preferable that a curve or straight line 30 above the stall torque curve 20 is used to provide continuous power in case of turbulent changes in water velocity.

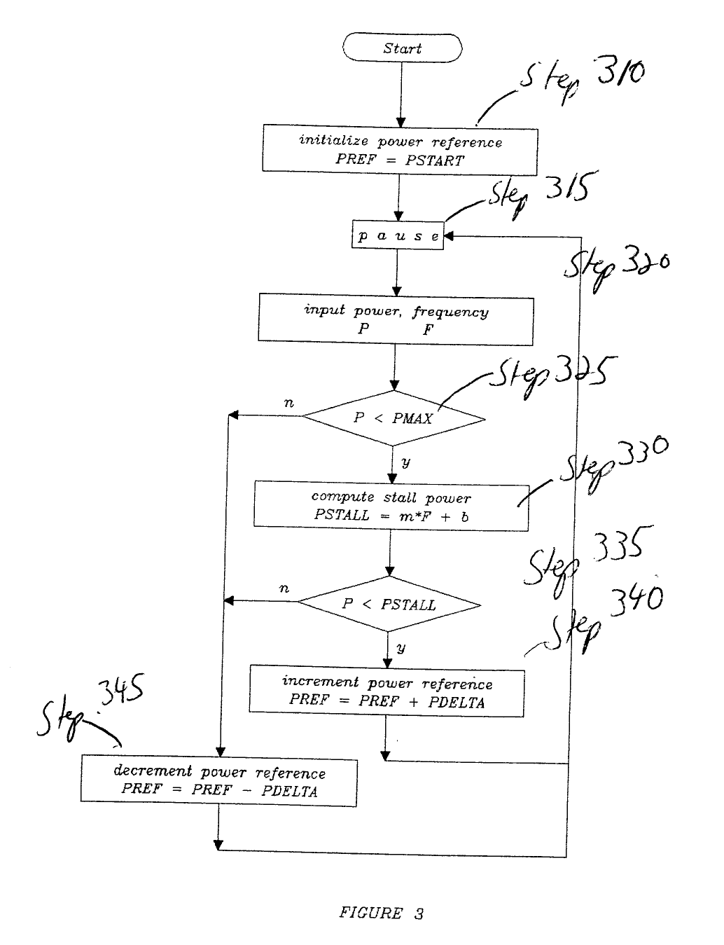

FIG. 3 illustrates an algorithm for finding and operating the maximum power available for any water velocity. At step 310, the system is initialized at a low power reference. The low power reference is with respect to the closed loop regulator within maximum power controller 160 (the maximum power controller being shown in FIG. 1). The regulator maintains the power delivered to the energy reservoir 150 so as to be the same as the power reference. Thus, the system starts with an initially low value being delivered to the reservoir.

At step 315, a pause is introduced to allow transient values to settle. Although the length of pause can be determined according to need, typically a pause is on order of ten to thirty seconds. After the pause at step 320, the input power and frequency are measured. At step 325 it is determined whether the power measured exceeds the maximum permitted power. If the power p is greater than the maximum permitted power (PMAX), the power reference is decremented at step 345. Then the algorithm reverts to step 315 and again performs steps 320 and 325. Otherwise, the algorithm proceeds directly from step 325 to step 330 where the stall power is calculated based on the frequency measured at step 320. It should be understood that the values at step 320 are the latest values of input power and frequency, if there has been a decrementing step and reversion to step 315.

At step 335, it is determined whether the value of the power p is greater than the stall power calculated at step 330. If the power p exceeds the stall power, then the power reference is decremented at step 345. After decrementing the power reference, the algorithm repeats at step 315. However, if at step 330, the value of the input power p is less than the stall power, the power reference is incremented at step 340 provided that it is safe to increase. Thus, the cycle continues with a return to the pause (step 315). As the water velocity changes, the algorithm will carry out the steps again to find the maximum power. It should be noted that the cycle can be interrupted for any programmed condition, such as a fault.

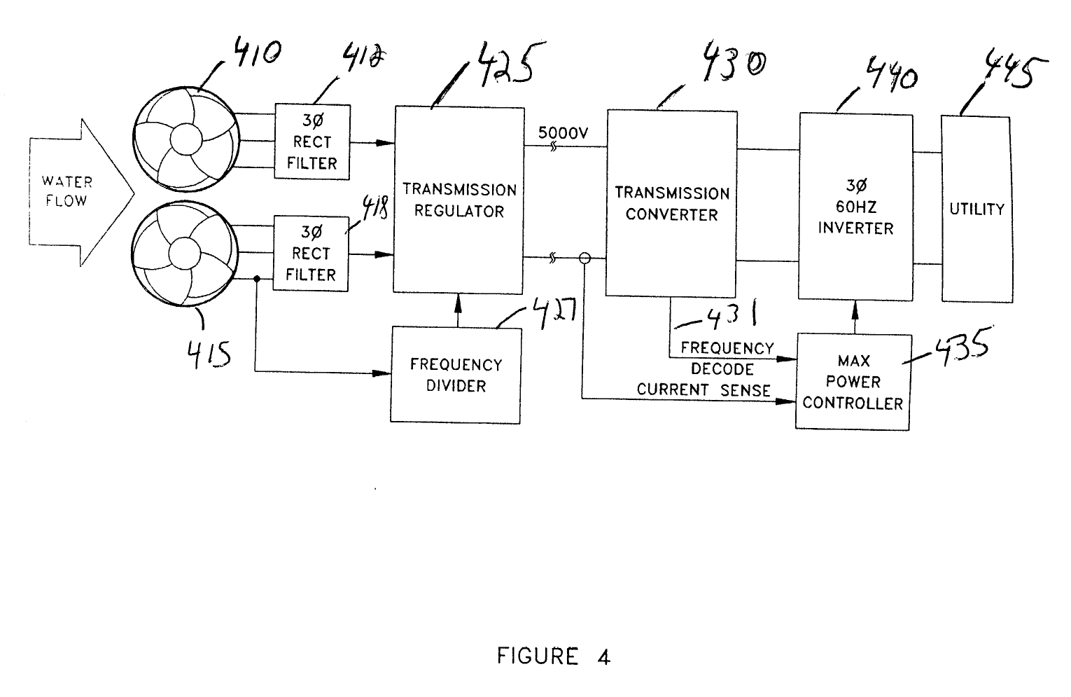

FIG. 4 illustrates an embodiment for an ocean current power generator according to the present invention. This embodiment is intended for operations at significant distances from the shore. Twin hydroturbines 410, 415, one of which preferably rotates clockwise and one counterclockwise, are connected to three-phase generators (not shown here but generator is shown in FIG. 1) through speed increaser gears. The frequency of the output from the generators is proportional to the hydro turbine shaft speed. The frequency of one (or both) generators is delivered to the transmission regulator 425. The power output from each of the generators is rectified by rectifiers 412, 418 prior to being delivered to the transmission regulator 425.

The output of the transmission regulator, in this particular embodiment, is a constant 5000 Vdc and is applied to the cable that connects the vessel in the ocean to the transmission converter 430, which can be located on shore. It should be understood by artisans that values other than 5000 Vdc could be output by the transmission regulator.

In addition, the frequency from the generators is applied to a frequency divider 427 to establish a low frequency proportional to the shaft speed that is then delivered to the transmission regulator 425. This low frequency can be used to modulate the 5000 Vdc so that frequency information is delivered to the maximum power controller 435 (via the frequency decode line 431) for maximum power consumption. There can be a modulator separate to, or part of the transmission regulator, or in communication with the frequency divider to perform the amplitude modulation. The transmission converter 430 is a dc-to-dc converter that reduces the transmitted voltage to a practical dc voltage for the inverter 440. The inverter 440 is a current source that applies power to the utility 445 as required to maintain the current from the transmission regulator 425 so that the maximum power is extracted from the ocean.

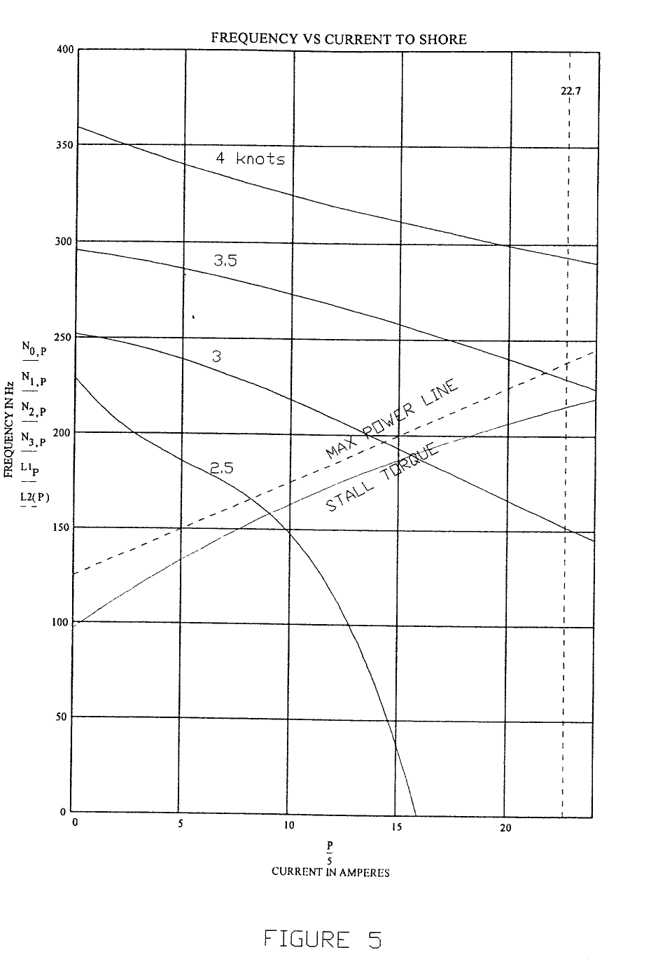

FIG. 5 illustrates a computed relationship of frequency vs. current to shore. However, in the case of actual installation of an Ocean Current Power Generator, FIG. 5 can be replaced by a set of calibration curves based on actual system performance in the actual environment, rather than calculated. It is of course, from these values that initial values of the maximum power, and maximum stall torque power are obtained to permit maximum power extraction at levels close to but not exactly at stall torque (As previously discussed).

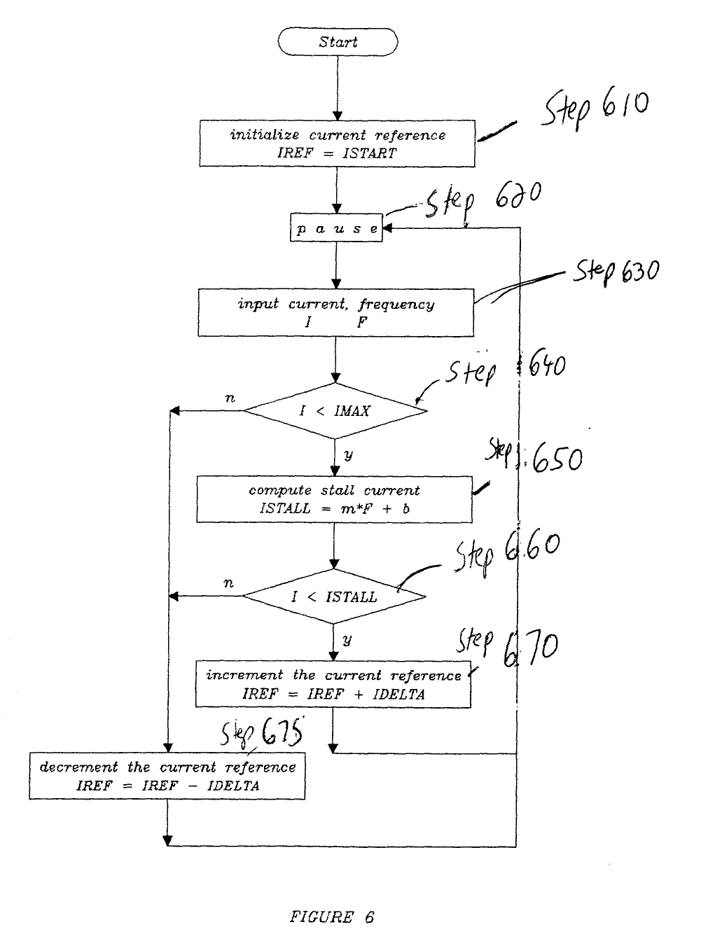

FIG. 6 is a flowchart illustrating one way that the maximum power controller may use current control for maximum power tracking according to the following algorithm:

At step 610, there is an initializing of the current output at a predetermined low current reference point;

At step 620, there is a pause in time to permit transient values to settle;

At step 630, there is a determination of the input current I and frequency f provided to the maximum power controller from the pair of turbo generators and the frequency sensed;

At step 640, there is a determination about the value of the input current I and the maximum permitted current IMAX, wherein the current IREF is decremented by a predetermined amount if the value of I measured at step 630 exceeds a maximum permitted current value (IMAX), and there is a repeating of step 620, 630 and 640 until the measured current I is below the maximum permitted current value IMAX;

The algorithm then proceeds to step 650, where the stall current is computed according to the frequency measured at step 630 using ISTALL=m*F+b;

At step 660, it is determined whether the stall torque current (ISTALL) is greater than the current I from step 630;

If the ISTALL is greater, then at step 670 the current reference is incremented (IREF=IREF+IA) and the algorithm returns to step 620.

However, if the ISTALL is less, then at step 675 the current reference is decremented and the algorithm returns to step 620. Thus the process is always using available current for maximum power extraction.

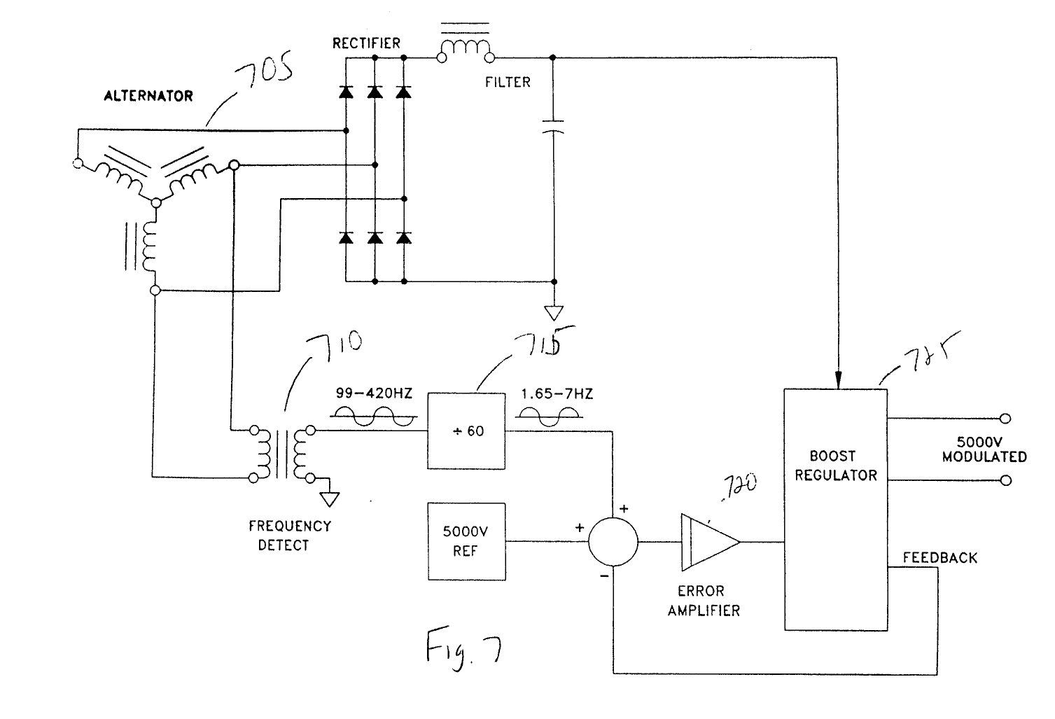

FIG. 7 illustrates a propeller speed communication link according to the present invention. It should be noted that the propeller speed link is shown for purposes of illustration, and there are various adaptations that are within the spirit of the invention and the scope of the appended claims. In this embodiment, a single alternator is illustrated so as not to obscure the theory of operation. If more than one alternator is used, each would contribute power to the boost regulator. The theory behind the propeller speed communication link is that the propeller RPM has a unique relationship with the water velocity and the power extracted from the flowing water. The power generated by the alternator is rectified, filtered, and used as an unregulated power for the boost regulator.

A frequency detect transformer 710 is connected to one of the phases of the three phase alternator 705, and provides a sine wave signal over an operating frequency range of approximately 99 to 420 Hz, which corresponds to water velocities of approximately 1 to 4 knots. The frequency is divided by divider 715 to a range suitable for transmission over the long cable to shore (for example 60), and it should be noted that other values (e.g. 70, 45, 30, 15,) and/or other than listed as examples can be used according to need. A filter can be optionally used in series with the frequency divider, to filter out particular harmonic frequencies.

A summing and/or error amplifier 720 adds the reduced frequency sine wave to a dc reference for the 5000 Vdc transmission voltage to serve as the reference to a Boost Regulator 725. The output of the boost regulator is 5000 volts modulated, with the propeller speed being used for modulating the amplitude and providing a communication link to shore using a single pair of wires for both power transmission and information transmission.

The communication link can also be used for transmitting emergency information, including but not limited to: 1) unbalanced power from the twin alternators; (2) over temperature in an alternator; (3) over temperature in the gear assembly; (4) over temperature in the electronics; (5) rectifier temperatures. There are many other types of emergency information that could be transmitted as well, both to the maximum power controller and/or to a receiving station and/or emergency personnel. This emergency message can include a distress signal.

The present invention is also well suited to extract maximum power from systems using tethered water current-driven turbines, including variable depth control turbine systems that maintain operating depths according to a predetermined minimum and maximum depth, such as disclosed in U.S. Pat. No. 6,091,161 to Dehlsen, which is hereby incorporated by reference as background material. Thus, the turbines may have variable pitch blades to adjust a drag force. The aforementioned algorithms are well-suited for maximum power extraction from the tethered water current-driven systems as well as other hydroturbine systems.

Various modifications may be made by persons of ordinary skill in the art that are within the spirit of the invention, and the scope of the appended claims. For example, the algorithms presented in FIGS. 3 and 6 are not the only way to use maximum power control; they are provided for purposes of illustration, not for limitation. Moreover, it should be understood that the number of hydroturbines, the type of energy reservoir can be changed according to need, the rectifiers, the type and/or degree of modulation of the dc power can be arranged according to need.

What is claimed is:

1. An apparatus for extracting a maximum amount of power from a water source, said apparatus comprising:
a hydroturbine assembly including a shaft;
a turbo generator connecting with the shaft of the hydroturbine assembly;
a frequency sensor for sensing a frequency output by the generator associated with a turbine speed of the hydroturbine;
a power converter that converts the electrical output of the turbo generator to a desired value;
a power sensor for sensing an output power of the power converter;
maximum power controller means that maximizes a power output of the power converter based on: (a) the frequency of the electrical output of the turbo generator sensed by the frequency sensor; and (b) the output power of the power converter sensed by the power sensor; and
an energy reservoir for receiving the output of the power converter;
wherein the maximum power controller means calculates the maximum possible power output of the power converter.

2. The apparatus according to claim 1, wherein the frequency sensed by the frequency sensor is communicated over the same two wires that the output of the power converter is transmitted.

3. The apparatus according to claim 2, wherein the maximum power controller means maximizes the power output of the power converter according to the following algorithm:
(i) initializing the power output at a predetermined low power reference point PREF;
(ii) introducing a pause of a predetermined amount of time to permit transient values to settle;
(iii) measuring an input power p and frequency f provided to the maximum power converter means from the turbo generator and the frequency sensed;
(iv) decrementing the reference power PREF (iii) by a predetermined amount if it has been determined that the power p measured in step (iii) exceeds a maximum permitted power value (PMAX) and returning to step (ii).
(v) calculating a stall torque power (PSTALL) according to the frequency and power measured at step (iii);
(vi) determining whether the stall torque power is greater than the power p in step (iv) that is below the maximum permitted power value; and one of
(vii) decrementing the reference power PREF by a predetermined amount if the value of the stall torque power PSTALL is greater than the power p and returning to step (ii); or
(viii) incrementing the reference power PREF by a predetermined amount if the value of the stall torque power is greater than the power p and returning to step (ii).

4. The apparatus according to claim 3, wherein said hydroturbine assembly comprises a tethered underwater current-driven turbine having variable depth control.

5. The apparatus according to claim 4, wherein said hydroturbine assembly comprises a pair of tethered underwater current-driven turbines including variable-pitch rotor blades.

6. The apparatus according to claim 1, wherein said hydroturbine assembly comprises at least two turbines, a first hydroturbine rotating in a clockwise direction and a second hydroturbine rotating in a counter-clockwise direction.

7. The apparatus according to claim 3, wherein said hydroturbine assembly comprises at least two turbines, a first hydroturbine rotating in a clockwise direction and a second hydroturbine rotating in a counter-clockwise direction.

8. The apparatus according to claim 3, wherein the frequency sensed by the frequency sensor is communicated over the same two wires that the output of the power converter is transmitted.

9. The apparatus according to claim 4, wherein the frequency sensed by the frequency sensor is communicated over the same two wires that the output of the power converter is transmitted.

10. The apparatus according to claim 3, wherein the energy reservoir comprises one of a battery, a fly wheel with the power converter including a motor for adding inertia to the fly wheel, or an ac power grid with the power converter including an inverter for delivering power to the ac system.

11. The apparatus according to claim 4, wherein the energy reservoir comprises one of a battery, a fly wheel with the power converter including a motor for adding inertia to the fly wheel, or an ac power grid with the power converter including an inverter for delivering power to the ac system.

12. The apparatus according to claim 3 wherein the power output of the power converter is high voltage direct current.

13. The apparatus according to claim 4 wherein the power output of the power converter is high voltage direct current.

14. An apparatus for extracting a maximum amount of power from a water source, said apparatus comprising:
a pair of hydroturbines having shafts;
a pair of three-phase generators, each one of the pair of three phase generators being connected to a respective one of said pair of hydroturbines;
a pair of three-phase rectifiers, each one three-phase rectifier being connected to an output of a respective one of said pair of three-phase generators;
a transmission regulator that receives a rectified power output from said pair of three-phase rectifiers, said transmission regulator outputting a constant predetermined high dc voltage;
a frequency divider that receives an unrectified output from said pair of hydroturbines, said frequency divider dividing a frequency of the unrectified output to a low frequency that is proportional to shaft speed of at least one of the pair of hydroturbines;
a transmission converter that reduces the constant high dc voltage output from the transmission regulator to a lower dc voltage;
means for maintaining a constant current output from the transmission converter; and
a maximum power controller that controls the means for maintaining a constant current output from the transmission regulator,
a modulator for modulating the high dc voltage by the low frequency proportional to shaft speed output from the frequency divider, so that the maximum power controller receives the current from the transmission regulator and the frequency information over the same two wires.

15. The apparatus according to claim 14, wherein said pair of hydroturbines comprises a tethered underwater current-driven turbine having variable depth control.

16. The apparatus according to claim 15, wherein said pair of hydroturbines comprise variable-pitch rotor blades.

17. The apparatus according to claim 14, wherein the modulator is included in the transmission regulator.

18. The apparatus according to claim 14, wherein the means for maintaining a constant current output comprises a three-phase inverter applying its output power to an ac power grid.

19. The apparatus according to claim 15, wherein the means for maintaining a constant current output comprises a three-phase inverter applying its output power to an ac power grid.

20. The apparatus according to claim 18, wherein the three-phase inverter includes outputs for providing current to a utility.

21. The apparatus according to claim 14, wherein the pair of hydroturbines, pair of three-phase generators, pair of three-phase rectifiers and frequency divider are arranged in a vessel located in a body of water, and wherein the transmission converter, means for maintaining, maximum power controller, and a utility are located on shore.

22. The apparatus according to claim 15, wherein the pair of hydroturbines, pair of three-phase generators, pair of three-phase rectifiers and frequency divider are arranged in a vessel located in a body of water, and wherein the transmission converter, means for maintaining, maximum power controller, and a utility are located on shore

23. The apparatus according to claim 14, wherein the transmission regulator includes a boost regulator system.

24. The apparatus according to claim 15, wherein the transmission regulator includes a boost regulator system.

25. The apparatus according to claim 14, wherein the boost regulator system includes a communication link for transmitting emergency messages over the same two wires as the current and frequency information.

26. The apparatus according to claim 15, wherein the boost regulator system includes a communication link for transmitting emergency messages over the same two wires as the current and frequency information.

27. The apparatus according to claim 14, wherein the maximum power controller utilizes maximum power tracking according to the following algorithm:
(i) initializing a current output at a predetermined low current reference point IREF;
(ii) introducing a pause of a predetermined amount of time to permit transient values to settle;
(iii) measuring an input current I and frequency f provided to the maximum power controller from the pair of turbo generators and the frequency sensed;
(iv) decrementing the current reference (IREF) by a predetermined amount if it has been determined that the current I measured in step (iii) exceeds a maximum permitted current value (IMAX), and returning to step (ii);
(v) calculating a stall torque current (ISTALL) according to the frequency and current measured at step (iii), wherein ISTALL=m*F+b;
(vi) determining whether the stall torque current is greater than the current I in step (iv) that is below the maximum permitted current value; and one of
(vii) decrementing the current reference (IREF) by a predetermined value if the value of the stall torque current is greater than the current I and returning to step (ii); or
(viii) incrementing the current reference (IREF) by a predetermined value if the value of the stall torque current is greater than the current I and returning to step (ii).

28. The apparatus according to claim 15, wherein the maximum power controller utilizes maximum power tracking according to the following algorithm:
(i) initializing a current output at a predetermined low current reference point IREF;
(ii) introducing a pause of a predetermined amount of time to permit transient values to settle;
(iii) measuring an input current I and frequency f provided to the maximum power controller from the pair of turbo generators and the frequency sensed;
(iv) decrementing the current reference (IREF) by a predetermined amount if it has been determined that the current I measured in step (iii) exceeds a maximum permitted current value (IMAX), and returning to step (ii);
(v) calculating a stall torque current (ISTALL) according to the frequency and current measured at step (iii), wherein ISTALL=m*F+b;
(vi) determining whether the stall torque current is greater than the current I in step (iv) that is below the maximum permitted current value; and one of
(vii) decrementing the current reference (IREF) by a predetermined value if the value of the stall torque current is greater than the current I and returning to step (ii); or
(viii) incrementing the current reference (IREF) by a predetermined value if the value of the stall torque current is greater than the current I and returning to step (ii).

29. The apparatus according to claim 14, wherein a first hydroturbine of the pair of hydroturbines rotates clockwise, and a second hydroturbine of the pair of hydroturbines rotates counter-clockwise, and a plurality of speed increaser gears, wherein said pair of hydroturbines are connected to the pair of three-phase generators, respectively, via the speed increaser gears.

30. The apparatus according to claim 15, wherein a first hydroturbine of the pair of hydroturbines rotates clockwise, and a second hydroturbine of the pair of hydroturbines rotates counter-clockwise, and a plurality of speed increaser gears, wherein said pair of hydroturbines are connected to the pair of three-phase generators, respectively, via the speed increaser gears.

31. A propeller speed communication link comprising:
means for receiving an alternating current having three phases generated by a propeller turbine;
a rectifier connected to the means for receiving, said rectifier outputting a main dc signal output and a reference signal;
a frequency detection transformer connected to the means for receiving an alternating current, said frequency detection transformer receiving one phase of said three phases of the alternating current;
a frequency divider that is connected to an output of the frequency detection transformer;
an adder having a first input connected to an output of the frequency divider, and a second input connected to the reference signal of said rectifier;
a boost regulator that has a first input that receives the main dc signal and a second input that receives an output of the adder, wherein said boost regulator modulates the main dc signal according to the output of the adder, so that the main dc signal and frequency information regarding a speed of the propeller turbine are transmitted over a same two-wire output.

32. The propeller speed communication link according to claim 31, further comprising means for communicating emergency information regarding a failure or a degradation of at least one component of the alternator rectifier, frequency detect transformer, adder and boost regulator.

33. A method for extracting maximum power comprising:
(a) providing a pair of hydroturbines having shafts and a pair of three-phase generators, each one of the pair of three phase generators being connected to a respective one of said pair of hydroturbines;
(b) dividing an output frequency of at least one phase of one of the pair of three-phase generators, so that said output frequency is divided to a lower frequency that is proportional to shaft speed of at least one of the pair of hydroturbines;
(c) providing a pair of three-phase rectifiers, each one three-phase rectifier being connected to an output of a respective one of said pair of three-phase generators;
(d) combining said pair of three-phase rectifiers to a single direct current output,
(e) regulating the output of the dc voltage by a regulator including a maximum power controller;
(f) modulating the high dc voltage by the low frequency proportional to shaft speed output from the frequency divider;
(g) providing the modulated dc voltage in step (f) and the frequency information generated in step (b) so that the maximum power controller receives the output current and frequency information over the same two wires.

34. The method according to claim 33, wherein:
wherein the regulator in step (e) comprises a boost regulator system including a communication link for transmitting emergency messages over the same two wires as the current and frequency information.

35. The apparatus according to claim 34, further comprising (h) transmitting emergency messages over the same two wires as the current and frequency information.

36. The method according to claim 33, wherein the regulating in step (e) includes providing a transmission converter for converting the predetermined dc voltage output to a lower dc voltage level.

37. The method according to claim 33, wherein said pair of hydroturbines provided in step (a) comprises a tethered underwater current-driven turbine having variable depth control.

38. The method according to claim 37, wherein said pair of hydroturbines provided in step (a) comprises a pair of tethered underwater current-driven turbines including variable-pitch rotor blades.

39. The method according to claim 33, wherein the maximum power controller in step (e) utilizes maximum power tracking according to the following algorithm:
(i) initializing a current output at a predetermined low current reference point IREF;
(ii) introducing a pause of a predetermined amount of time to permit transient values to settle;
(iii) measuring an input current I and frequency f provided to the maximum power controller from the pair of turbo generators and the frequency sensed;
(iv) decrementing the current reference (IREF) measured in step (iii) by a predetermined amount if it has been determined that the current I exceeds a maximum permitted current value (IMAX) and returning to step (ii);
(v) calculating a stall torque current (ISTALL) according to the frequency and current measured at step (iii), wherein ISTALL=m*F+b;
(vi) determining whether the stall torque current is greater than the current I in step (iv) that is below the maximum permitted current value; and one of
(vii) decrementing the current reference (IREF) by a predetermined value if the value of the stall torque current is greater than the current I and returning to step (ii); or
(viii) incrementing the current reference (IREF) by a predetermined value if the value of the stall torque current is greater than the current I and returning to step (ii).

40. The method according to claim 37, wherein the maximum power controller in step (e) utilizes maximum power tracking according to the following algorithm:
(i) initializing a current output at a predetermined low current reference point IREF;
(ii) introducing a pause of a predetermined amount of time to permit transient values to settle;
(iii) measuring an input current I and frequency f provided to the maximum power controller from the pair of turbo generators and the frequency sensed;
(iv) decrementing the current reference (IREF) measured in step (iii) by a predetermined amount if it has been determined that the current I exceeds a maximum permitted current value (IMAX) and returning to step (ii);
(v) calculating a stall torque current (ISTALL) according to the frequency and current measured at step (iii), wherein ISTALL=m*F+b;
(vi) determining whether the stall torque current is greater than the current I in step (iv) that is below the maximum permitted current value; and one of
(vii) decrementing the current reference (IREF) by a predetermined value if the value of the stall torque current is greater than the current I and returning to step (ii); or
(viii) incrementing the current reference (IREF) by a predetermined value if the value of the stall torque current is greater than the current I and returning to step (ii).

41. A method for maximizing power extraction by a power controller, comprising:
(i) initializing a power output at a predetermined low power reference point PREF;
(ii) introducing a pause of a predetermined amount of time to permit transient values to settle;
(iii) measuring an input power p and frequency f provided to the power controller from a hydroturbine generator and a frequency sensor, respectively;
(iv) decrementing the reference power PREF step (iii) by a predetermined amount if it has been determined that the power p measured in step (iii) exceeds a maximum permitted power value (PMAX), and returning to step (ii). (v) calculating a stall torque power (PSTALL) according to the frequency and current measured at step (iii);
(vi) determining whether the stall torque power is greater than the power p in step (iv) that is below the maximum permitted power value; and one of
(vii) decrementing the reference power PREF by a predetermined amount if the value of the stall torque power PSTALL is greater than the power p and returning to step (ii); or
(viii) incrementing the reference power PREF by a predetermined amount if the value of the stall torque power is greater than the power p and returning to step (ii).
